(19) United States
(12) Patent Application Publication
(10) Pub. No.: US 2003/0023622 A1
(43) Pub. Date: Jan. 30, 2003

(54) Manual activity persistence in content management workflow systems

(75) Inventors: L. Lance Obermeyer, Austin, TX (US); Nathaniel B. Forman, Austin, TX (US); Keith Yarbrough, Austin, TX (US)

Correspondence Address: William N. Hulsey III, Hughes & Luce, L.L.P., Suite 2800, 1717 Main Street, Dallas, TX, 75201, US

(73) Assignee: Liaison Technology, Inc., Austin, TX

(21) Appl. No.: 10/053,175

(22) Filed: Nov. 13, 2001

Related U.S. Application Data
(60) Provisional application No. 60/308,306, filed on Jul. 27, 2001.

(51) Int. Cl. G06F 15/00

(52) U.S. Cl. 707/500

(57) ABSTRACT

The invention is directed to an automated workflow management system. The automated workflow management system may manage content records in a workflow process. For example, the automated workflow management system may prepare data records for storage in a database. Further, the automated workflow management system may prepare content for a catalog. The automated workflow management system may prompt users to act on documents that violate a business logic rule. The automated workflow management system may observe and record user actions. Further, the automated workflow management system may persist those recorded user actions as persisted activities. In addition, the automated workflow management system may replay or repeat the persisted activities. These persisted activities may be associated with specific content records. Further, the user actions may take the form of decisions, editing, classifying, and others. These decisions may be to discard the content record or bypass the business rule. These editing actions may be to change, manipulate, delete, and add content. Further, these classifying actions may be to apply a structure and/or taxonomy to a content record. As such, cross file repetition may be reduced.

This application is based on and claims priority from Provisional Application Serial No. 60/308,306, filed Jul. 27, 2001.

### FIELD OF THE INVENTION

The present invention generally relates to a document management system. In particular, the present invention relates to a system and associated methods for automatically directing and editing content in a workflow process. By automatically directing and editing content in a workflow process, cross file repetition is reduced.

### BACKGROUND OF THE INVENTION

Document management is becoming increasingly useful in many different businesses. One example is businesses associated with sales and distribution. These companies develop electronic catalogs and databases of product prices and associated product availability.

The advent of e-commerce dramatically increased the quantity and rate of content flow throughout the commerce chain. As a result, higher quality content can be provided to customers. However, there are many problems and limitations associated with the content management systems as they are at present.

A distributor or sales organization may need to coordinate an electronic catalog or sales database that has many different products from many different manufacturers or distributors. Periodically, each of the manufacturers may send the distributor or sales organization a data update, often a spreadsheet file or database table containing, for example, the product number, description, price, and availability, among others. Each of these products may represent a record in an electronic catalog. However, distributors and sales organizations may have difficulty maintaining a single electronic catalog composed of many different products from many different suppliers.

Distributors or sales organizations have two problems maintaining an electronic catalog composed of supplier provided content. First, a single supplier update may contain errors or inconsistencies within the data file. These are intra file problems. For example, a supplier may represent weight in pounds while the distributor or sales organization may represent weight in ounces. These errors and inconsistencies must be corrected before the supplier content may be loaded into the electronic catalog database. Second, a single supplier may send multiple updates over time, such as a weekly price update. Since the products sold by a supplier tend to vary little over time, most of the content of these periodic updates is unchanged from the prior update. Therefore, a specific intra file problem may be repeated for every update, multiplying the problem. A repeated problem is a cross file repetition problem or a temporal repetition problem.

Previously many content workers were required to solve the cataloging problems. In addition, many non-standard solutions were provided to attempt to automate these problems. Both the large number of content management workers associated with the catalog process or the non-standard automated software processes led to exorbitant costs associated with managing electronic catalog content. Further, these methods left their electronic catalogs sparsely populated, difficult to establish and update, inconsistent, erred, and expensive to maintain.

In addition, as electronic catalogs grew more and more content was required to be incorporated into the catalogs. With content workers and/or proprietary content management systems the process was not scaleable. As more content was presented for processing, more workers were hired or more software development was required.

In addition, previous solutions especially proprietary software failed to associate automated activities with individual content. Instead, broad generic rules were provided for content from a supplier or associated with a spreadsheet. These broad generic rules solved only intra file problems, ignoring cross file repetition problems.

One problem associated with these content management systems is found in identifying content associated with cataloged items. As new data becomes available, it must be identified and associated with an item in the electronic catalog. The identification process may be time consuming and require much labor.

Another problem associated with present content management systems is the repetitive nature of many of the activities associated with changing or updating content. Once the content is identified, time must be spent updating the electronic catalog to reflect new information. For example, much of the content may be in the form of a weekly update. Each weekly update from a given supplier or across suppliers may have the same error. Content workers repeat the same task across these files. As such, cross file repetition of work is required. Again, much labor may be required. Additionally, the accuracy of the content may suffer as a result of human error.

These problems may result in high operating costs and inaccurate catalog content. Many employees are required to perform the activities associated with managing catalog content. More employees increase the operating costs. When more activities are available than employees to perform them, the accuracy of the data in the electronic catalog suffers. In addition, many content management systems are inflexible and unscalable.

As such, many typical content management systems suffer from deficiencies in providing accurate solutions at a reasonable cost. Many other problems and disadvantages of the prior art will become apparent to one skilled in the art after comparing such prior art with the present invention as described herein.

### SUMMARY OF THE INVENTION

Aspects of the present invention are found in a content management system. The content management system may include an automated content identification system. The content management system may also include a content editing function.

Another aspect of the invention may be found in a system for automating repetitive activities. These activities may include identifying content associated with specific items, editing identified content, discarding identified content, flagging content, and others. These activities may also be cataloged, edited, deactivated and applied, among others. In addition, these activities may be tracked, undone and redone. As such, this aspect may reduce cross file repetition.

A further aspect of the invention may be found in a system for observing activities. The system may identify and/or suggest activities that may be automated. These activities may include editing content, classifying content, evaluating decision parameters, and others.

An additional aspect may be found in an interface between the systems above and other applications. This interface enables the system to alter online, database, and syndicated content, among others.

Another aspect of the invention may be found in a method for workflow management. The method may direct the path of content. Further, the method may direct the application and automation of activities. The method may also permit selectively applying automated activities.

Another aspect of the invention may be found in a method for observing activities. The method may also include identifying activities that may be automated. The method may also permit selectively automating identified activities.

An additional aspect of the invention may be found in a medium used to distribute instructions for operating the systems above. Further, an aspect of the invention may be found in a method for distributing the software instruction set for operating the systems above.

As such, a system and method for automating tasks relating to identification and management of content records is described. Other aspects, advantages and novel features of the present invention will become apparent from the detailed description of the invention when considered in conjunction with the accompanying drawings.

### BRIEF DESCRIPTION OF THE DRAWINGS

The present invention is illustrated by way of example and not limitation in the accompanying figures, in which like references indicate similar elements, and in which:

FIG. 1 is a schematic block diagram of an automated workflow management system according to the invention.

FIG. 2 is a schematic block diagram of an automated workflow management system according to the invention of FIG. 1.

FIG. 3 is a block flow diagram of an exemplary usage of the invention of FIG. 1.

FIG. 4 is a block flow diagram of another exemplary usage of the system of FIG. 1.

FIG. 5 is a block flow diagram of an exemplary method for use by the system of FIG. 1.

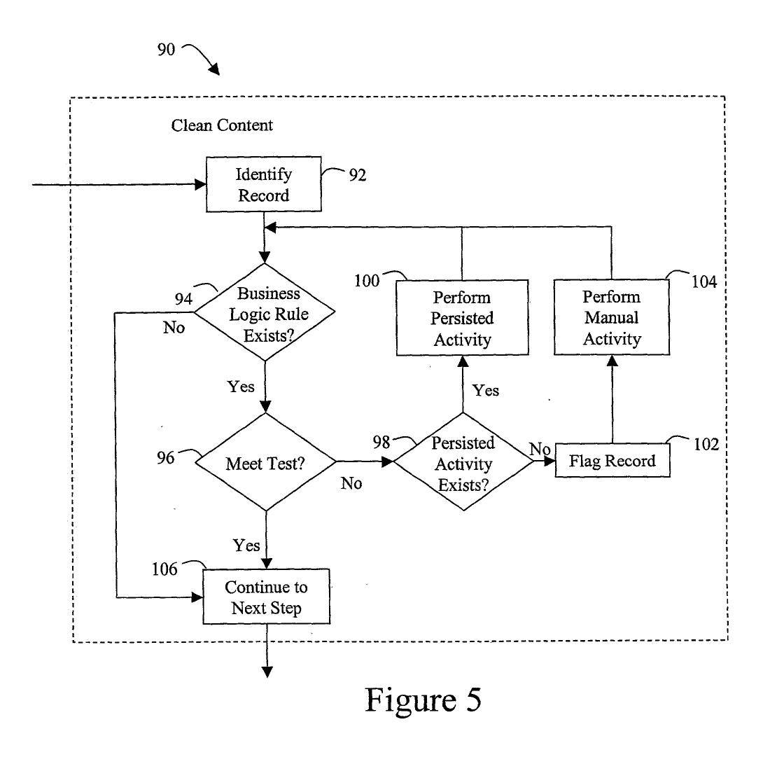

FIG. 6 is a block flow diagram of another exemplary method for use by the system of FIG. 1.

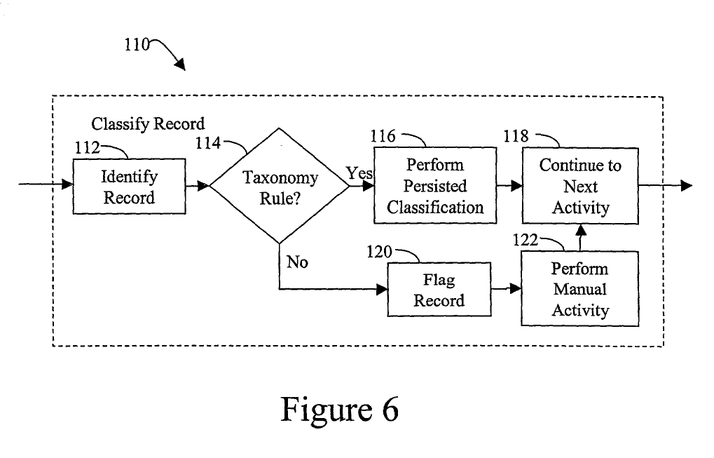

FIG. 7 is a block flow diagram of a further exemplary method for use by the system of FIG. 1.

FIG. 8 is a block flow diagram of another exemplary method for use by the system of FIG. 1.

FIG. 9 is a block flow diagram depicting a method for use by the system of FIG. 1.

FIG. 10 is a block flow diagram of an exemplary method for use by the system of FIG. 1.

FIG. 11 is a block flow diagram of an exemplary method for use by the system of FIG. 1.

### DETAILED DESCRIPTION OF THE PREFERRED EMBODIMENT

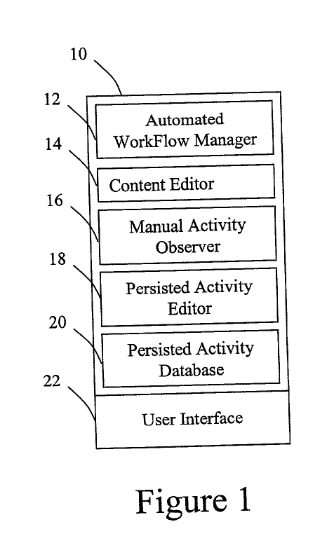

FIG. 1 is a schematic block diagram depicting an automated workflow management system according to the invention. The automated workflow management system 10 may include an automated workflow manager 12, a content editor 14, a manual activity observer 16, a persisted activity editor 18, a persisted activity database 20, and a plurality of user interfaces 22. Some all or none of these may be included. These items may also be included in a single unit, in multiple units, or in various combinations.

The automated workflow management system 10 is a system for managing content records, data files, and documents, among others, in a workflow process. The system 10 directs the content records, data files, and documents, among others, through a series of workflow step. For example, a weekly update of item pricing and availability may be acquired from a supplier. The automated workflow management system 10 may, for example, identify records within the update, test the records against business logic rules, and selectively edit and classify the records using persisted activities.

These workflow steps may take various forms. These forms may include extracting, acquiring, cleaning, classifying, loading, distributing, sending, editing, updating, and merging content records, to name a few. These workflow steps may, for example, be a series of steps to direct data into a database or electronic catalog file. Alternately, the workflow steps may alter a second content in a manner associated with the content record. For example, an image file or HTML document may be altered to reflect information included in a pricing update.

Workflow steps may have, for example, two parts, a business rule and an associated process for compensating for exceptions to the business rule. For example, content records not conforming to a business rule may be identified, herein flagged. These flagged content records may fail to proceed in the workflow process. Further, these flagged content records may be acted upon. This action may place the content records in conformity with the business rule.

This action may take various forms. These forms may include editing, changing, and manipulating aspects of the content record, among others. Further, these forms may include decisions to discard the content record, bypass the business rule, make a new rule, or others. In addition, these actions may be performed manually or automatically.

The content record may take various forms. These forms may include data records, data files, text documents, spreadsheets, log files, data streams, and bit streams, among others. Further, the content record may be part of a content file. In addition the content may have content fields. Herein the term content may be interchangeable between the content file, content record and content field, among others. Further, this content may take various forms including data fields in a data record, cells in a spreadsheet, text in a text document, bits in a bit stream, and others.

The automated workflow management system 10 may have a set of business logic rules. These rules may take various forms. These forms may include rules regarding values of content fields, text strings in fields, the absence of values, and others. Further, in one exemplary embodiment a rule may be always false or always true. In addition, the automated workflow management system 10 may have means for editing, storing, recalling, changing, manipulating, and testing business logic rules.

In one embodiment, the automated workflow management system 10 directs content records containing price and availability, for example, through a workflow process designed to clean the content, categorize the content, and place the content into a database or electronic catalog. The electronic catalog can then be accessed on line, through a website, or through commands such as extensible markup language (XML). Further phone sales organizations and in-store sales organizations can access the data to determine pricing and availability of products.

By going through the automated workflow management system process, the data may be automatically cleaned, classified, updated, reconciled, and presented with limited intervention by a content worker. Further, the database or electronic catalog may be used in placing world wide web-based orders accessible by distributors, buyers, and/or consumers.

The automated workflow manager 12 may direct the content record through the workflow process by comparing the content to a series of business logic rules. To accomplish this, the workflow manager 12 may identify the content, compare it to any rules, determine if the content record conforms to the rules, and selectively determine what task is to be performed. The work task may be created if a record fails a business rule. The work task may be categorized as either a manual activity or persisted activity. Manual activities are activities performed by a user. Persisted activities are activities performed by the system. By performing the persisted activity, cross file repetition is reduced. For example, the persisted activity may repetitively edit content received periodically from a supplier in a weekly update of item pricing and availability.

Persisted activities may be automated activities based on activities that have previously been manually entered. These automated activities may be initiated by a user or may be recorded activities previously performed by a user. Further, these persisted activities may be instructions, programs, steps, or codes that enable the automated workflow management system 10 to replay or repeat the manual activity. In one embodiment, the workflow manager 12 directs the content through the series of steps to clean and categorize the content for storage in an electronic catalog or database. For example, repeated discrepancies in subsequent versions of content records may be repaired automatically.

The content editor 14 may act to alter content in its preparation in the workflow process. The content editor 14 may take various forms. These forms may include a text editor, field editor, structure editor, word processor, form editor, bit editor, image editors, video editors, sound editors and others. In one exemplary embodiment, the content editor 14, may function to edit the content of the content record while maintaining the structure of the content record. In another exemplary embodiment, the content editor may classify the content record and/or change the structure of the content record. Further, the content editor 14 may function to manipulate, change, and adjust, the content and/or the structure of the content record. In addition, the content editor may edit a second content in response to the content record. For example, the content editor may edit an HTML document in response to a content record. In another example, the content editor may edit an image file to include a price value of a price field in a price list update.

The manual activity observer 16 may function to observe or observe and temporarily remember activities performed by the user on an identified content record. The manual activity observer 16 may also suggest activities that may be persisted or automated. Further, the manual activity observer 16 may function to record manual activities, program automated forms of these manual activities, and store those as persisted activities in the persisted activity database. As such, the persisted activities may be used to automate tasks performed on subsequent versions of the content record.

The manual activity observer 16 may, for example, create a persisted activity record. The persisted activity record may include fields identifying the content record and/or the business logic rule associated with the persisted activity. The persisted activity record may also include a representation of the persisted activity and/or instructions for replaying the persisted activity. The representation may take a text, Boolean or other form. The instructions may take many forms. These forms may include Javascripts, SQL, Perl scripts, Visual Basic, C++, and XML, among others. Further, the manual activity observer 16 may function to formulate, program, and/or manipulate the instructions associated with the persisted activity.

For example, a user may edit a data field in a data record. The manual activity observer may selectively record the actions of the user. Then, the manual activity observer may suggest that the actions of the user be persisted. With the consent of the user, the manual activity observer may then save a set of instructions enabling the automated workflow system 10 to repeat or replay the manual activity. Further, the manual activity observer may save the persisted activity in a persisted activity database 20. In addition, the manual activity observer may associate the persisted activity with a specific content record. The manual activity observer 16 may take various forms. These forms may include a software-based observer, an artificial intelligence solution, a keystroke recorder, a historian, and others.

The persisted activity editor 18 may act to allow users to view, edit, delete, deactivate, activate, and reprogram persisted activities. Further, the persisted activity editor 18 may permit users to associate persisted activities with a given content or a given business logic rule. The persisted activity editor 18 may function to access the persisted activity database. Further, the persisted activity editor may be access by and may access the manual activity observer 16.

The persisted activity database 20 functions to store persisted activities. The persisted activity database 20 may associate a persisted activity with a specific content record, classification, business logic rule, and/or exception to a business logic rule. The persisted activity database may be accessed by the manual activity observer 16 and the persisted activity editor 18. The manual activity observer 16 may store persisted activities in the persisted activity database 20. Further, the persisted activity editor 18 may function to edit the persisted activity database 20. In addition, the persisted activity editor 18 may store persisted activities and associate them with content and business logic rules.

The persisted activity database 20 may take various forms. These forms may include a relational database, an object database, a text listing, a spreadsheet, and others.

The user interface 22 may act to permit users to perform manual functions or manual activities on content records. Further, the user interface 22 may function to permit users to access the persisted activity editor 18 to edit persisted activities stored in the persisted activity database 20. In addition, the user interface may allow users to respond to prompting by the manual activity observer 16 or the automated workflow manager 12. The user interface 22 may take various forms. These forms may comprise monitors, displays, terminals, network devices, networked computers, keyboards, and others.

A history of previously performed persisted activities and manual activities may also be saved. This history may also be associated with individual content. In this way, activities may be undone or replayed or the process by which content was created or edited may be observed. This content record history may be utilized in an undo manner, in a replay manner, or redo manner. Further, the content history may be stored in a content history database.

The automated workflow management system 10 may take many forms. These forms may include a single server with a single user interface, multiple computers linked through a network each with a user interface, a series of network devices performing individual functions or combination of functions, or various combination of the above, among others.

The system and methods presented above may function to reduce cross file repetition during the workflow process for content record handling. By limiting user interaction, both the time associated with user activity and errors caused by users are reduced or eliminated. As such, content may be cleaned and prepared in a more efficient manner. Cross file repetition may be reduced. Further, the cost of managing content databases associated with the content of the electronic catalog is reduced.

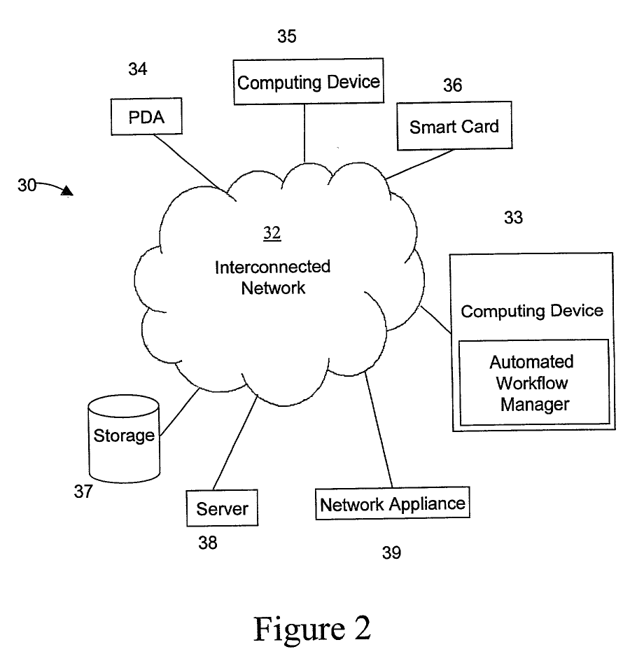

FIG. 2 is a schematic block diagram of an interconnected system according to the invention of FIG. 1. The system 30 may include a computing device with an automated workflow management system connected to an interconnected network 32. The interconnected network 32 may have attached to it other network devices. These devices may include, for example, a network storage device 37, a server 38, a network appliance 39, a personal digital assistant 34, other computing devices 35, and others.

The interconnected network 32 may take many forms. These forms may include a local area network (LAN) and a wide area network (WAN). These forms may also include wireless communication means and hardwired means. These means may be combined in any configuration. The communication means may include a telephone line, an Ethernet connection, a wireless Ethernet connection, a two-way paging system, a mobile phone system, infrared communications, satellite communication, radio communication, and RS-232 hardwired communication, among others. The communications means may utilize several protocols and standards including the Reflex (TM) two-way paging standards, the Bluetooth (TM) wireless communications standard, Ethernet 802.11, cellular phone standards such as (CDPD, AMPS, GSM, CDMA), packet radio standards (mobitex (TM), DataTec(TM)), TCP/IP protocols and others.

The system 30 may function in many ways. For example, content may be delivered to the computing device 33, through the interconnected network 32, or from other devices on the network. Then, the automated workflow management system on the computing device 33 may direct manual activities to be performed on other devices connected to the network 32. For example, these devices may include the PDA for other computing devices 35, servers 38, network storage 37, and other network appliances 39, among others. Further, the computing device 33 with the automated workflow manager may direct that content be stored in a storage device 37. In addition, the automated workflow management system may direct that an automated workflow process performed on other computing devices 35, or other servers 38, for example. In addition, the automated workflow manager system may prepare content for display on other devices connected to the interconnected network such as website servers, XML servers, sales databases, and others.

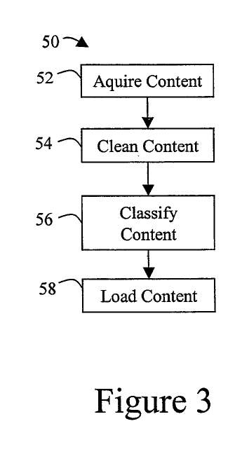

FIG. 3 is a block flow diagram of an exemplary usage of the system of FIG. 1. The method 50 directs that the automated workflow management system first acquire content as seen in block 52. Then, in block 54, the content is cleaned. The content may be acquired through the interconnected network, from files and databases, or data streams, among others. For example, a content record may be acquired from a spreadsheet sent by a supplier. Further, for example, the content record may be acquired through an XML server.

Cleaning the content may include editing, adding, manipulating, copying, and deleting fields of the content, among others. For example, a data field in a data record may be edited to a specific format. For example, a computer parts catalog may list memory chips. An automated workflow management system may change a data field to read “1 M” from “1024 K”. This enables the computer parts catalog to specify a common format for storing and displaying memory chip information despite multiple suppliers with multiple specification formats.

In block 56, the content may then be classified. Classification may involve reading the content, determining if the content fits into a known taxonomy and applying any known taxonomies to the content. Further, multiple taxonomies may be applied to the content. In the computer parts catalog example, the automated workflow management system may determine that a specific model number from a specific vendor indicates data relating to memory chips. The content record structure may then be changed to include the new classification. This structure may conform to a data structure in a database.

Next, in block 58, the content is loaded into a database, for example, according to its classification and conformance to business logic rules. The content may also be stored or directed to a further work step or sent across the interconnected network of FIG. 2.

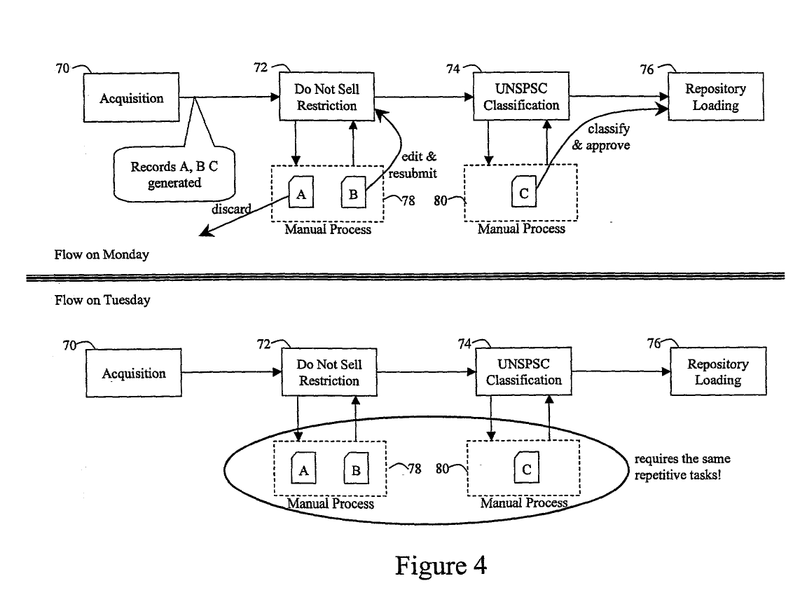

FIG. 4 is a block flow diagram of an exemplary usage of the system of FIG. 1. In FIG. 4 a series of work steps are depicted as would be performed on two separate days. In block 70 content is acquired for example, records A, B, and C are generated from the acquired content. The content management system then delivers the content to a next step within the process.

As depicted by block 72, in this example, a restriction exists for records A and B containing the phrase “do not sell.” The restriction may be a business logic rule in the automated workflow management system. The “do not sell” may, for example, be a message within the content or in a data field of the content. However, the “do not sell” phrase may have two differing contexts. For example, the “do not sell” phrase in record A may be the result of the discontinuance of a product A represents. On the other hand, the “do not sell” phrase in record B may be a flag indicating low profit margins on a product B represents.

On a first day, in this example Monday, A and B are sent to manual processing. In manual processing a user may be prompted to make a decision or perform some task in relation to these records. In this example, record A may be discarded and record B may be edited and resubmitted to the process. Record B is then forwarded to the next step in the workflow process.

In the next step, as represented by block 74, the content may require classification. This classification may be used to aid in storing the content or determining the content's final destination. In this example, a record C requires classification and is sent to a manual classification process. The record C may, for example, be missing a data field used in classifying the content record. In the manual classification process as represented by block 80, the user may direct or classify the content. Once the classification is approved, it is then sent to the next step in the process. The next step, as represented by block 76, may be storage in a database or forwarding the document on to some other system.

On a second day, for example a Tuesday, the process may be repeated. As represented by block 70 the content is acquired. In this example records A, B, and C are generated. Normally, the same steps would need to be repeated as in the day before. However, with an automated content management system with persisted activities, these steps may be automated. For example, a manual activity observer may have determined the day before that these steps and tasks could be automated for these specific records. These tasks may then have been stored in a persisted activity database and edited with a persisted activity editor. With the automated workflow management system the task could have been performed automatically on a subsequent day.

In this example, record A could have been discarded, record B edited and submitted and record C classified without the intervention of a user. With the automated workflow management system user interaction is reduced, errors eliminated, and significant savings result. As such, cross file repetition is reduced. With less user interaction time, labor costs are saved. In

Further, the act of classifying the content record may change the structure of the content record. For example, classifying a record may added one or more fields to the record.

In this exemplary method, in a first block 112, a new record is identified. In the next block 114, it is determined whether a taxonomy rule exists for the identified record. If a taxonomy rule does not exist, the record is flagged as shown by block 120 for manual performance. A user may then be directed to perform a manual activity or manual classification of the record as seen in block 122. The record may then be forwarded to a next step in the workflow process as seen in block 118.

If a taxonomy rule does exist, then the automated workflow management system may automatically apply the taxonomy rule as seen in block 116. The content may then be forwarded through the workflow process as shown in block 118. This process may, for example, prepare a record for storage in an electronic catalog or database.

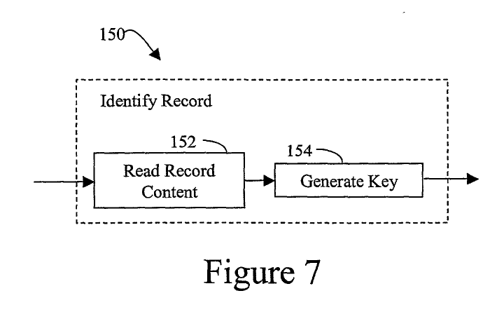

FIG. 7 is a block flow diagram of a further exemplary method for use by the system of FIG. 1. The method 150 is a method for identifying records. This identification method for the identity of records may be used in comparing those records with persisted activities within a persisted activity database or against business logic rules associated with specific identified content records. In the method 150, the content record is read as seen in block 152. Next, in block 154, a key is generated. The generated key may be derived from the content of the record, fields within the record, or other aspects associated with that individual record among others.

For example, a content record identifying a certain product may use a model number and a vendor number in order to generate the key identifying the record. Further, for example, the key may be generated using features, structures, fields, keywords, bit values, and others.

By identifying specific content records, rules and persisted activities may be associated with specific records. This feature enables exception handling on an item-by-item basis. Further, the key may be generated in various manners for various steps in a workflow process. This enables documents to be identified by aspects relevant to the specific workflow steps.

Further, the structure of content records may be used as a record key. This record key may be used to generate a record identifier. In one exemplary embodiment, a record may hold information about a manufacturer, a product number, and a version. The record identifier may then be generated as manufacturer:product_number:version. For example, a record identifier may look like Acme:100:A. Further, the record identifier may be generated despite missing and/or blank fields. For example, the identifier may take the forms: Acme::S, Acme:100:, and :100:S, among others.

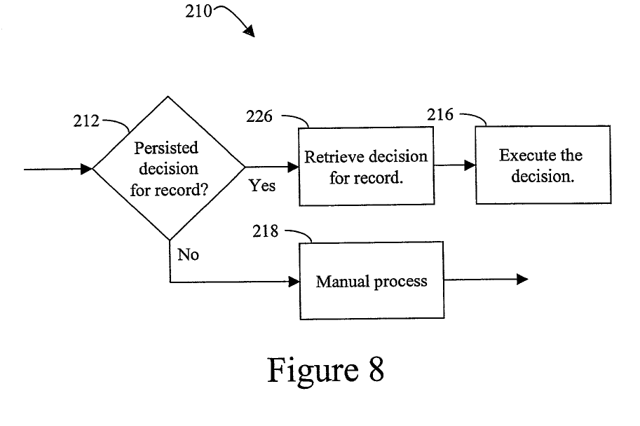

FIG. 8 is a block flow diagram of another exemplary method for use by the system of FIG. 1. The method 210 may function to persist a decision activity. A decision activity may be to discard, approve, or forward the content record, among others. Further, a decision activity may be to bypass a rule. In addition, the decision activity may be persisted.

In a block 212 it is determined whether a persisted activity or persisted decision activity exists for the content record. If a persisted decision activity does not exist for the record the record may be forwarded to a manual process as described above and as seen in block 218. If a persisted activity decision does exist for the record, the automated workflow management system may retrieve the decision activity associated with the individual record as seen in block 214. Next, as seen in block 216, the automated workflow management system may execute the decision associated with the individual record. The individual record may then be forwarded in the workflow process if appropriate.

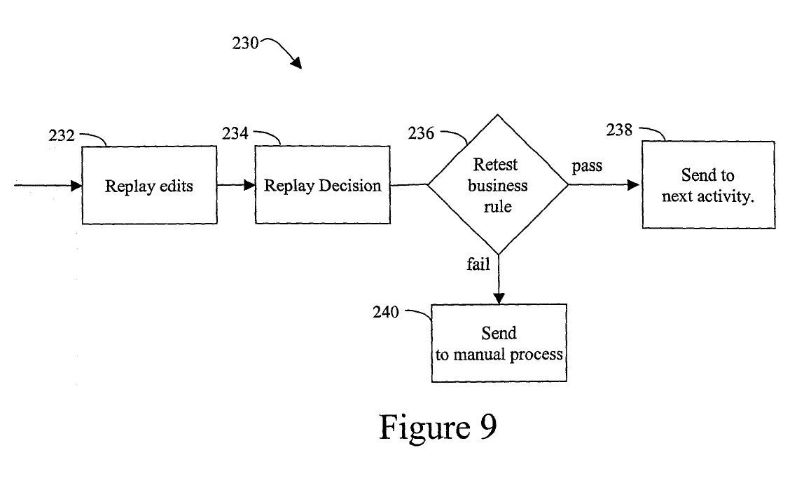

In FIG. 9 an exemplary method is shown which may replay persisted activities and decisions as performed by the automated workflow management system. FIG. 9 is a block flow diagram depicting a method for use by the system of FIG. 1.

In a first block 232, the automated workflow system may replay edit activities that have been persisted. These edit activities may be activities that have been persisted, previous manual activities that have been recorded, or other programmed activities among others. The replay refers to performing persisted activities and persisted edit activities associated with the individual record as found in the persisted activity database or replaying the history of the persisted edit activities. These edit activities may include changing, deleting, formatting, and manipulating content in a content record, among others.

The content record may then be forwarded to a next block 234 where the decision activities may be replayed. These decision activities may be associated with the individual record and may also be found in a persisted activity database or an activity history. For example, the decision may be to discard the content record. As such, the process may end. Alternately, the decision may be to approve the document and/or bypass other business rules. As such, the process may continue to the next activity in the workflow process.

As seen in a block 236, the content record may then be tested against business logic rules to determine whether the content conforms to these rules. One of these tests may, for example, be whether a rule exists or whether the content has been dealt with before. If the content does not conform to the business logic rule or if the content does not have an associated business content rule, the content may be sent for manual processing as seen a block 240. On the other hand, if the content does conform to the business logic rule, the content may be sent to a next activity within the workflow process as seen in block 238.

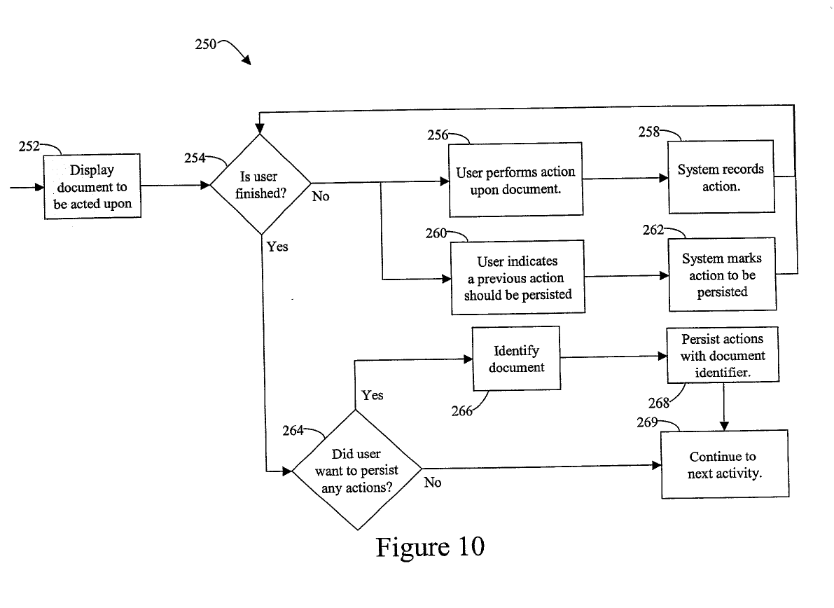

FIG. 10 is a block flow diagram of an exemplary method for use by the system of FIG. 1. The method 250 may be used by the automated workflow management system to observe manual activities determined whether persisted activities exist and to manage the content record through the workflow process.

In a block 252, a document that, for example, failed a business logic rule may be displayed to the user. The user may then determine whether an activity needs to be performed on the content record as seen in block 254. If the user does need to perform a manual activity and is not finished working with the content record, the user may perform the manual activity on the content record or may direct that a previously recorded action be taken on the content record. For example as seen in block 256, the user may perform an action on the document or content record. The system may record this action as seen in block 258. On the other hand, the user may indicate that a previously recorded persisted activity should be performed on the content record as seen in block 260. The previously performed persisted activity may not have been previously associated with the individual content record. As seen in block 262, the system may then associate the individual content record with the persisted activity and perform the persisted activity. In this manner, the content may be automatically edited, classified, or adapted to conform to the business logic rules and/or be prepared for storage.

Once the user has completed all tasks associated with the individual record, the system may prompt the user to persist those activities as seen in block 264. If the user wishes to persist the activities, the automated workflow management system may then identify the document or content record as seen in block 266. This identification may for example involve generating a key associated with the individual content record. In a next block 268, the persisted action may be stored with or associated with the content record in a persisted activity database. In this manner, the manual activity observer may function to observe, suggest and persisted previous manual activities. The manual activity may create a set of instructions for repeating the manual activities and associate those instructions with the persisted activity. The content may then be forwarded to a next step in the workflow process as seen in block 269.

If the user does not wish to persist the activity, the document may then be forwarded to a next step in the workflow process as seen in a block 269. The user, for example, may not want to persist an activity if the activity represents a one-time exception to a rule, if it is anticipated that the document is a one-time occurrence, if the user may for some reason desire to perform the activity manually in the future, and others.

Further, a persisted activity may be performed that does not place the content in conformance with a business logic rule. As such, a manual activity may subsequently be performed on the content and this manual activity may be observed and persisted.

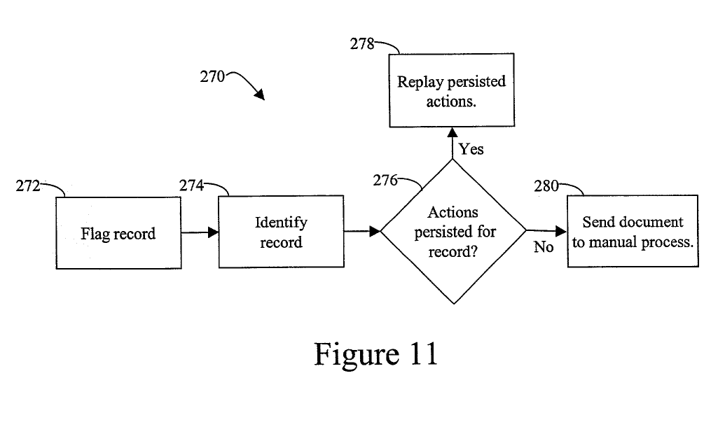

FIG. 11 is a block flow diagram of an exemplary method for use by the system of FIG. 1. The method 270 represents another exemplary method for processing documents.

In a block 272 a record may be acquired and flagged for processing. For example, a document may be flagged for not meeting a business rule, missing structure, having an error or others. Next, in a block 274, the record may be identified. This identification may involve generating a key associated with the record. It may then be determined whether a persisted activity exists for the record or whether the record conforms to a business logic rule. If a persisted activity associated with the record does exist, that persisted activity may be replayed or performed on the record as seen in a block 278. If, however, it is determined that a persisted activity record does not exist for the identified record, the record may be sent for manual processing as seen in a block 280.

As such, an automated workflow management system is described. In view of the above detailed description of the present invention and associated drawings, other modifications and variations will now become apparent to those skilled in the art. It should also be apparent that such other modifications and variations may be effected without departing from the spirit and scope of the present invention as set forth in the claims which follow.

What is claimed is:

1. A method for selectively persisting a manual activity performed by a user of a workflow system, the manual activity being a work step performed by the user and associated with a specific record, the method comprising:
selectively determining whether the manual activity associated with the specific record is to be persisted; and
selectively persisting the manual activity in the event that the manual activity is to be persisted, the persisting comprising adding a persisted activity record to a persisted activity database.

2. The method of claim 1, the method further comprising:
displaying the specific record;
selectively determining whether to perform a manual action associated with the specific record or to perform a persisted action associated with the specific record;
selectively performing the manual action associated with the specific record in the event that the manual action should be performed; and
selectively performing the persisted action associated with the specific record in the event that the persisted action should be performed.

3. The method of claim 2 wherein the specific record is displayed when the specific record does not conform to a business logic rule.

4. The method of claim 1 wherein the persisted activity record is associated with the specific record.

5. The method of claim 1 wherein the persisted activity record is associated with a business logic rule.

6. The method of claim 1 wherein the persisted activity record comprises instructions for replay of the manual activity.

7. The method of claim 1 wherein the specific record is contained in a new version of a recognized file.

8. The method of claim 1 wherein the specific record is acquired from a supplier.

9. The method of claim 1, the method further comprising:
subsequently storing the specific record in an electronic catalog.

10. A method for automatically performing a persisted activity in a workflow process, the persisted activity associated with a persisted activity record, the persisted activity record associated with an individual content record, the method comprising:
identifying the individual content record;
determining whether the persisted activity record associated with the individual content record exists; and
selectively performing the persisted activity associated with the persisted activity record on the individual record.

11. The method of claim 10, the method further comprising:
determining whether the individual content record conforms to a business logic rule.

12. A content management workflow system operable to automatically adjust at least one content field of at least one content record, the content management workflow system operable to load the at least one content record into a catalog database, the content management workflow system comprising:
an automated workflow manager operable to selectively direct the at least one content record to at least one step in a workflow process using at least one business logic rule;
a persisted activity database operable to store at least one persisted activity associated with the at least one content record;
the persisted activity database in communication with the automated workflow manager, the automated workflow manager operable to selectively replay the at least one persisted activity stored in the persisted activity database;
a content editor operable to adjust the at least one content field of the at least one content record.

13. The content management workflow system of claim 12, the content management workflow system further comprising:
at least one user interface coupled to the automated workflow manager, the at least one user interface operable to permit at least one manual activity associated with the at least one content record.

14. The content management workflow system of claim 13, the content management workflow system further comprising:
a manual activity observer in communication with the at least one user interface, the manual activity observer operable to observe the at least one manual activity, suggest at least one persisted manual activity operable for replay of the at least one manual activity, and load the at least one persisted manual activity into the persisted activity database, the at least one persisted manual activity associated with the at least one content record.

15. The content management workflow system of claim 14 wherein the manual activity observer creates instructions operable to replay the at least one manual activity.

16. The content management workflow system of claim 14 wherein the at least one persisted manual activity becomes a persisted activity upon storage in the persisted activity database.

17. The content management workflow system of claim 12, the content management workflow system further comprising:
a persisted activity editor coupled to the persisted activity database, the persisted activity editor operable to permit viewing and editing of the at least one persisted activity.

18. The content management workflow system of claim 12 wherein the content editor is operable to adjust the at least one content field of the at least one content record such that the at least one content record conforms to a business logic rule.

19. The content management workflow system of claim 12 wherein a document is altered in a manner associated with the at least one content record.

20. A program storage device readable by a machine, tangibly embodying a program of instructions executable by the machine to perform methods steps for automatically persisting a manual activity, said method steps comprising:
selectively determining whether an action on a specific record is to be persisted; and
selectively persisting the action on the specific record in the event that the action is to be persisted, the persisting comprising adding a persisted activity record to a persisted activity database.
